(19) United States
(12) Patent Application Publication
(10) Pub. No.: US 2005/0021443 A1
(43) Pub. Date: Jan. 27, 2005

(54) Trading data visualisation system and method

(76) Inventors: Thomas Richard Beard, Wellington (NZ); Paul Allan Cardno, Wellington (NZ)

Correspondence Address: Nicholas John Mulgan;Suite 270, 2625 N Green Valley Parkway, Las Vegas, NV, 89014, US

(21) Appl. No.: 10/625,876

(22) Filed: Jul. 24, 2003

(51) Int. Cl. G06F 17/60

(52) U.S. Cl. 705/37

(57) ABSTRACT

The invention provides a trading data visualisation system comprising a transaction database stored in computer memory of transaction data representing transactions in relation to one or more tradable items, the transaction data comprising one or more data sets, one or more of the data sets comprising an item identifier, a transaction identifier and an item volume value. The system also includes a retrieval component configured to retrieve transaction data from the transaction database and a display configured to display one or more graphical representations of some or all of the transaction data, the size of one or more of the graphical representations proportional to the volume of tradable items represented by the transaction data. The invention also provides related methods of visualising trading data.

### FIELD OF INVENTION

The invention relates to a trading data visualisation system and method, particularly but not solely designed to assist a trader in buying and selling tradable items such as stocks, shares, futures, convertible securities, bonds and tradable utilities.

### BACKGROUND TO INVENTION

The advance of technology has increased the number of avenues for investors to trade stocks, introducing elements of immediacy and the choice of investment in many global markets. It is possible for example for an investor to place funds in a very broad range of investment vehicles, for example tradable items in the form of stocks, shares, futures, convertible securities, bonds and even trading in items such as utilities. This trend has increased the importance of trader performance and highlighted new business problems for these traders.

Trading on a financial market involves traders purchasing and selling large numbers and types of stocks and shares. This requires the trader to maintain an overview of the whole market while focusing on an individual trade. Many systems currently on the market fail to do this and are limited to low bandwidth text views. Decisions regarding the selection of which stocks to trade involves in-depth analysis of a vast number of listed stocks. One difficulty is that price movements in stocks are triggered by any number of financial, market, economic and/or social factors. Graphical tools currently on the market generally indicate just one factor relevant for a stock at a particular time and these tools are based at the consumer level.

Most traders maintain what is known as an order book providing an individual trader with instructions regarding individual stocks. These instructions could be for example to sell a certain volume of particular stocks at a minimum price or better by a certain time. Likewise, the order book could contain instructions to purchase a certain volume of stocks at a certain price or less by a certain time. It is necessary for a trader to constantly check the order book to make sure that orders are being fulfilled and to check price movements of individual stocks relevant to the order book. Many systems currently on the market maintain an order book as a separate application to the main trading display which tends to be inconvenient for a trader.

It would be particularly advantageous to provide a trader with a trading data visualisation system which provides all the necessary data in a graphical format to assist traders in stock selection and in carrying out instructions in an order book.

### SUMMARY OF INVENTION

In one form the invention comprises a trading data visualisation system comprising a transaction database stored in computer memory of transaction data representing transactions and desired transactions in relation to one or more tradable items, the transaction data comprising one or more data sets, one or more of the data sets comprising an item identifier, a transaction identifier and an item volume value; a retrieval component configured to retrieve transaction data from the transaction database; and a display configured to display one or more graphical representations of some or all of the transaction data including at least one desired transaction, the size of one or more of the graphical representations proportional to the volume of tradable items represented by the transaction data.

In another form the invention comprises a method of visualising trading data comprising the steps of maintaining in computer memory a transaction database of transaction data representing offers for sale, offers to buy and concluded sales in relation to one or more tradable items, the transaction data comprising one or more data sets, one or more of the data sets comprising an item identifier, a transaction identifier and an item volume value; retrieving transaction data from the transaction database; and displaying one or more graphical representations of some or all of the transaction data including at least one offer for sale or offer to buy, the size of one or more of the graphical representations proportional to the volume of tradable items represented by the transaction data.

### BRIEF DESCRIPTION OF THE FIGURES

Preferred forms of the trading data visualisation system and method will now be described with reference to the accompanying figures in which:

FIG. 1 shows a block diagram of a system in which one form of the invention may be implemented;

FIG. 2 shows the preferred system architecture of hardware in which the present invention may be implemented;

FIG. 3 shows one preferred form display of a trading stock in accordance with the invention;

FIG. 4 shows an order book generated in accordance with the invention;

FIG. 5 shows a combined trading stock display and order book; and

FIG. 6 shows the combined display of FIG. 5 generated for several stocks.

### DETAILED DESCRIPTION OF PREFERRED FORMS

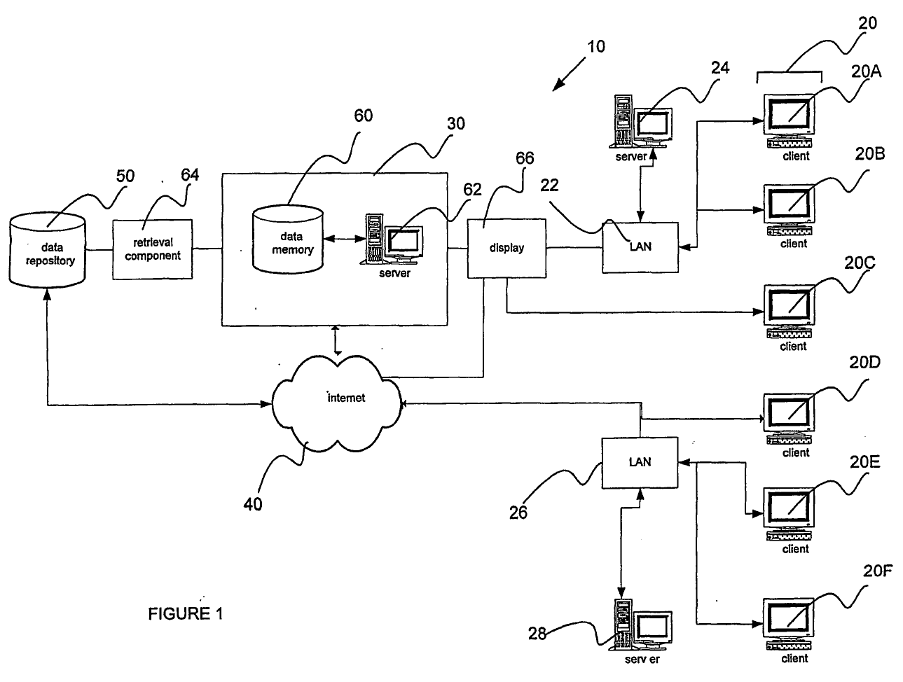

FIG. 1 illustrates a block diagram of the preferred system in which one form of the present invention 10 may be implemented. The system includes one or more clients 20, for example 20A, 20B, 20C, 20D, 20E and 20F, which each may comprise a personal computer or workstation described below. Each client 20 is interfaced to the invention 30 as shown in FIG. 1. Each client 20 could be connected directly to the invention 30, could be connected through a local area network or LAN, or could be connected through the Internet.

Clients 20A and 20B, for example, are connected to a network 22, such as a local area network or LAN. The network 22 could be connected to a suitable network server 24 and communicate with the invention 30 as shown. Client 20C is shown connected directly to the invention 30. Clients 20D, 20E and 20F are shown connected to the invention 30 through the Internet 40. Client 20D is shown as connected to the Internet 40 with a dialup or other suitable connection and clients 20E and 20F are shown connected to a network 26 such as a local area network or LAN, the network 26 connected to a suitable network server 28.

The preferred system 10 further comprises a data repository 50, for example a data warehouse maintained in a memory. It is envisaged that the data repository may alternatively comprise a single database, a collection of databases, or a data mart. The preferred data repository 50 includes data from a variety of sources. The data repository may include, for example, interaction data representing offers for sale, offers to buy and concluded sales in relation to tradable items such as stocks and shares, futures, bonds and utilities.

One preferred form of the invention comprises a personal computer or workstation 30 operating under the control of appropriate operating and application software having a data memory 60 connected to a server 62. The invention is arranged to retrieve data from the data repository 50, process the data with the server 62 and to display the data on a client workstation 20 as described below. The invention could include a retrieval component 64 which in one form could be a software implemented query component enabling a user to retrieve specific data from the data repository 50. The invention could also include a display 66 which in one form could include a software implemented routine programmed to format data retrieved from the data repository 50 to display on a client 20. It is also envisaged that the display 66 could comprise combination hardware and software which could be implemented in a specific client device 20.

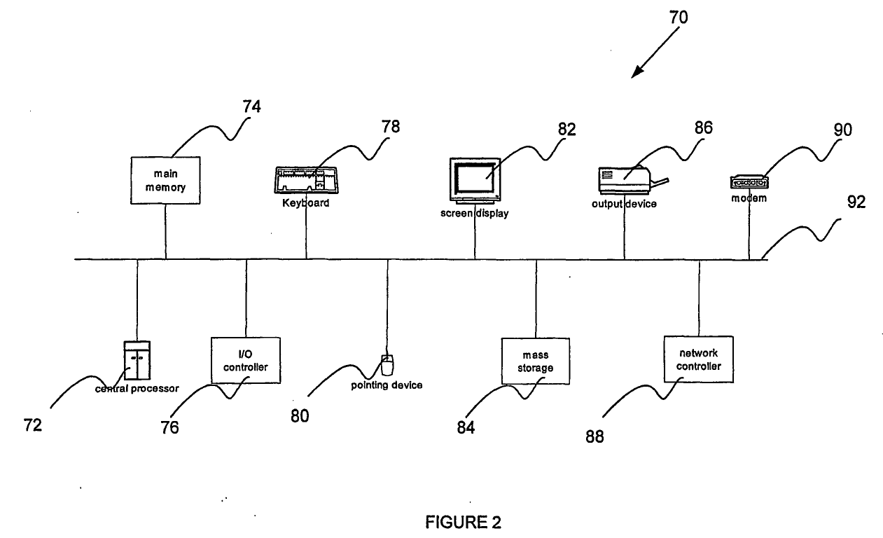

FIG. 2 shows the preferred system architecture of a client 20 or workstation 30. The computer system 70 typically comprises a central processor 72, a main memory 74 for example RAM and an input/output controller 76. The computer system 70 could also comprise peripherals such as a keyboard 78, a pointing device 80 for example a mouse, a display or screen device 82, a mass storage memory 84 for example a hard disk, floppy disk or optical disc, and an output device 86 for example a printer. The system 70 could also include a network interface card or controller 88 and/or a modem 90.

The individual components of the system 70 could communicate through a system bus 92, or alternatively could be distributed from each other and interfaced over a network. It is envisaged that a client could be provided in the form of a handheld computing device having a touch sensitive screen and a data input component in the form of a stylus as an alternative to a keyboard and pointing device. Such a handheld device could communicate with other components of the system using wireless technology.

It is envisaged that the data stored in the data repository could be stored in mass storage 84 of the invention 30, in a client workstation 20, or on a further data memory interfaced to the invention 30 and/or client 20.

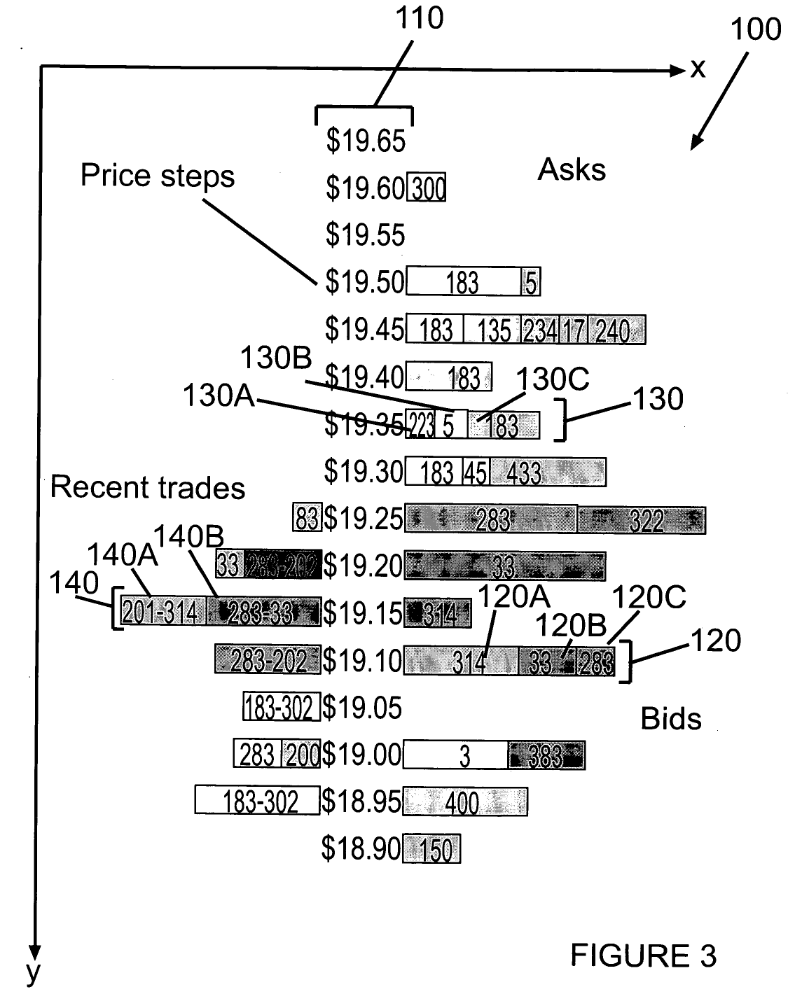

FIG. 3 illustrates at 100 one example of a screen display generated by the system in which the items traded include stocks and shares. A display of an individual stock is presented to a user on screen display 82 of a client 20.

As shown at 110, a graduated scale of prices in relation to individual stock could be shown. As indicated in FIG. 3, the price could decrease in steps of 5 cents inversely proportional to the position displayed on the screen. Each price could be displayed in a text box centered on an (x,y) coordinate. As y values increase, the price value could decrease.

During the course of a trading day, various quantities of the individual stock are offered for sale at a sale price known as an “ask” and offers to buy certain volumes of stocks are made at a buying price, each offer known as a “bid”. When “bids” and “asks” are matched, a trade is concluded. A transaction in relation to an individual trading stock includes “bids”, “asks” and “trades”. Each transaction is preferably represented by a data set. One or more of the data sets include an item identifier unique to the individual stock being traded, a transaction identifier which preferably characterises the transaction as either a “bid”, an “ask” or a “trade” and an item volume value representing the volume of shares in the transaction. The transaction data could further include a time value representing the time of the transaction, and/or a currency value representing the price of the transaction.

As transactions are made in relation to individual trading stocks, these transaction data sets are preferably stored in the data repository 50. The retrieval component 64 retrieves these transaction data sets from the data repository and the display 66 generates and displays graphical representations of each transaction on a client workstation 20.

In a further preferred form, each transaction is performed by a registered trader or broker, each trader having a trader identifier. In one form, each transaction could further include a trader identifier in relation to a “bid” and an “ask”. It is envisaged that a concluded trade may have two trader identifiers, one trader who has entered the bid and another trader who has entered the ask.

Examples of transactions in the form of bids are indicated at 120 for example. Bids 120A, 120B and 120C each represent bids by different traders for the stock shown in FIG. 3 at a price of $19.10. One or more of the graphical representations 120 is preferably shown as a rectangular box, although it is envisaged that other shapes or symbols could be presented. The area or size of one or more of the boxes is preferably proportional to the volume of shares involved in the transaction. For example bid 120A involves a larger volume of shares than bid 120B and 120C and so bid 120A is shown as a larger box than that of 120B and 120C.

The position of one or more of the boxes in the display depends on factors such as the price value and time in the transaction data sets. The colour of one or more of the boxes depends on the time value and also on the type of transaction. Preferred variations in the positioning, size and colour property of each box will be described below.

One or more of the boxes is preferably defined by an (x,y) coordinate for example in the top left of the box. The y value is preferably calculated as a function of the price value in the transaction data set. Lower price transactions are preferably awarded higher y values to position lower price transactions closer to the lower end of the display.

In one preferred form, transactions are displayed in a queue with more recent transactions toward the right hand side of the screen and older transactions toward the left hand side. In FIG. 3, bid 120C is more recent than bid 120B which in turn is more recent than 120A. To calculate an appropriate x value for each new transaction, the invention could calculate the x value as a function of the time of the transaction and the volume and hence size of the graphical representation of earlier transactions. In this way, one or more of the graphical representations of a transaction are positioned relative to other graphical representations based on the time value in each data set.

Individual transactions are preferably also displayed in a colour based on the time value of each transaction. Recent transactions are displayed in a darker colour, while older transactions are displayed in a lighter colour. In one preferred form, transactions are displayed initially in a dark colour which gradually fades as the age of the transaction increases.

Individual transactions could also be displayed in a colour based on the transaction identifier. Bids for example could be displayed in red, asks could be displayed in green and recent trades could be displayed in blue.

In this way, graphical representations of one or more transactions could have a colour property based on the transaction identifier in each data set, depending on whether a transaction identifier indicates the transaction as a bid, an ask or a trade. Furthermore, each of the graphical representations could have a colour property based on the time value in each data set, as each representation has an initial intensity which changes as the age of the transaction increases.

As described above, each transaction data set could include a trader identifier. These traders or brokers could be identified by a number displayed in the center of the box. For example, bid 120A is put forward by broker 314, whereas bid 120B is put forward by broker 33 and bid 120C is put forward by broker 283.

Individual asks are presented in a similar form, for example as shown at 130, at price $19.35. The asks include 130A, 130B and 130C. It will be appreciated that bids will tend to be toward the lower end of the scale, whereas asks will tend to be toward the higher end of the scale.

The x position of each representation of a transaction is preferably also calculated as a function of the transaction identifier. Bids and asks are preferably displayed on the right hand side of the scale. As bids and asks are matched, a trade is concluded and a representation of the trade is displayed on the left hand side of the scale. Recent trades are indicated for example at 140 in which 140A and 140B show examples of two different trades concluded at a price of $19.15. Once again, the volume in each trade determines the size of the box. Recent trades are preferably represented in a queue in which recent trades are placed adjacent to the graduated scale and move leftward according to time. Each trade could include a trader identifier for the bid and a trader identifier for the ask.

Each recent trade could once again be presented in a darker colour which becomes lighter as the age of the trade increases.

At each price step, the total market volume can be easily appreciated, along with the size of each order. Since time is represented by a colour scale, the most recent transactions are presented in a darker colour and are the most obvious and changes in supply and demand are apparent even before trades are made. The above representation would assist a user in quickly identifying trends in the sale and purchase of individual trading stocks.

One preferred form of the invention could also display to a user an order book. Customers wishing to buy or sell particular stocks place an order with a trader. Such orders typically include the number or volume of stocks to be sold of a particular type, a minimum or maximum price, and a time by which the transaction should be completed. These orders are preferably stored according to the invention as a series of order data sets representing potential transactions in relation to one or more of the shares, also referred to as desired transactions. The desired transactions are preferably stored as transaction data sets in the data repository 50, where they are retrieved by retrieval component 64, and graphical representations generated and displayed by the display 66. It will be appreciated that the desired transaction sets could alternatively be stored in any suitable form separate from the data repository 50.

One or more of the order data sets preferably comprises a stock identifier identifying the individual stock to be the subject of the order, a transaction identifier indicating whether the stock is to be bought or sold, a time value indicating the preferred time by which the order should be completed, a volume indicating the amount of stock to be traded, and/or a price.

When the order for example is to sell a quantity of stock, the price would be a minimum price whereas if a quantity of stock is to be bought, the price will typically be a maximum price.

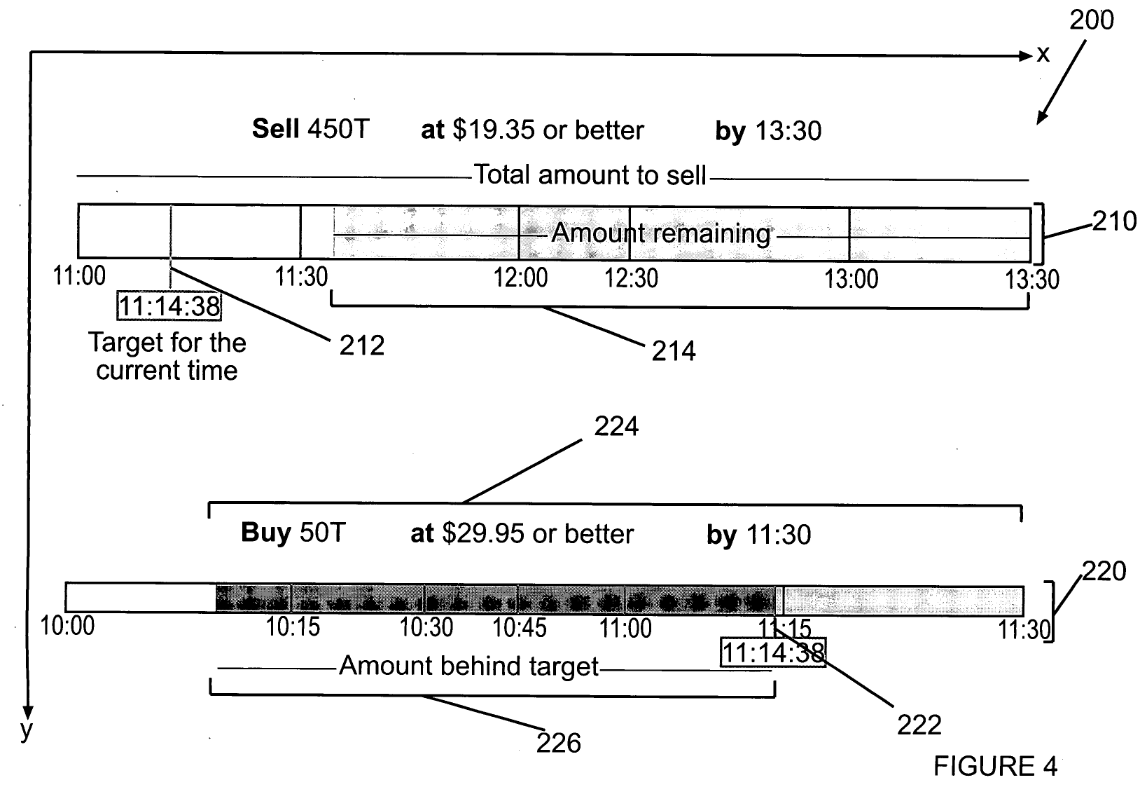

FIG. 4 illustrates a preferred order book displayed to a user on a client 20 in accordance with the invention. The order book 200 could include for example a representation of an order to sell a particular stock as shown at 210. The order 210 is preferably displayed as a single shape for example a bar. The area of the bar is preferably proportional to the amount of stock to sell and in a preferred form the y values of bar 210 are adjusted depending on the size of the order.

Order 210 is an order to sell 450,000 units of a particular stock at a price of $19.35 or better by 1.30 pm. A time indicator 212 provides a user with a theoretical order completion schedule which indicates a target of sale for the current time. The coloured section of the bar as indicated at 214 shows the proportion of stocks remaining for the trader to sell. It can readily be appreciated from the representation that this particular trader is ahead of schedule.

Order 220 shows an order to buy 50,000 units of a stock at a price of $29.95 or less by a deadline of 11.30 am. Once again, the order is preferably represented as a bar having an area proportional to the size of the order. A time indicator 222 indicates the theoretical order completion schedule. The area 224 indicates the proportion of the stock still to buy. It can be readily appreciated from the representation that the trader is behind target as indicated by area 226.

Preferably all buy orders are displayed in red, the same colour as that reserved for bids, and all sell orders are displayed in green, the same colour as that reserved for asks. Where a trader is behind target, the proportion of the total order by which the trader is behind is preferably indicated in a darker colour to draw a trader's attention to the deficiency.

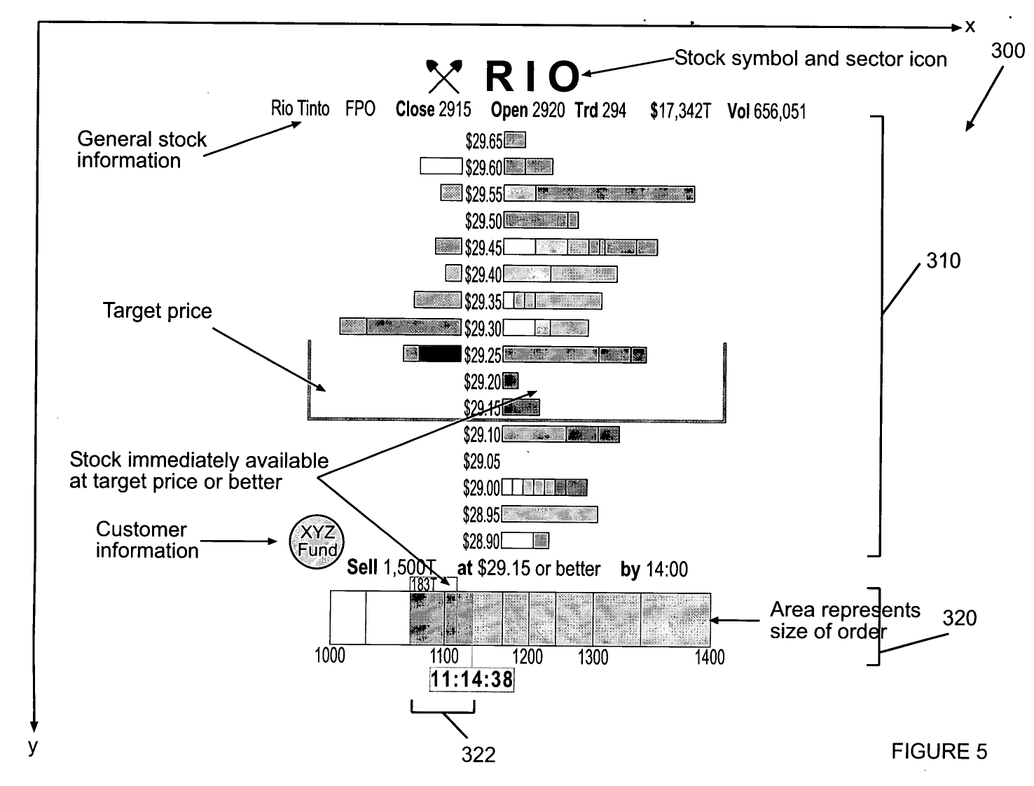

An important feature of the invention, as shown in FIG. 5, is in displaying a graphical representation 310 of one or more transactions and displaying data 320 from the order book together. As shown in FIG. 5, individual transactions involving a particular stock are displayed in the same manner described with reference to FIG. 3. Positioned beneath the transaction representations could be an order book for a trader involving that stock in a similar manner to that described above with reference to FIG. 4. In this way graphical representations of both actual transactions and desired transactions in relation to one or more tradable items are displayed.

The order book in FIG. 5 contains an order to sell 1.5 million units of Rio stock at a price of $29.15 or better by a time of 2.00 pm. As shown in FIG. 5, this particular trader is running behind schedule as indicated by area 322. A target price bracket indicated at 330 could be positioned at a y position in the display corresponding to the minimum price for sale of the stock. In this way, a trader is immediately provided with an indication of the stock immediately available at the target price or better. All the trader needs to do is scan the bids and asks above the target price bracket 330 for the best bid.

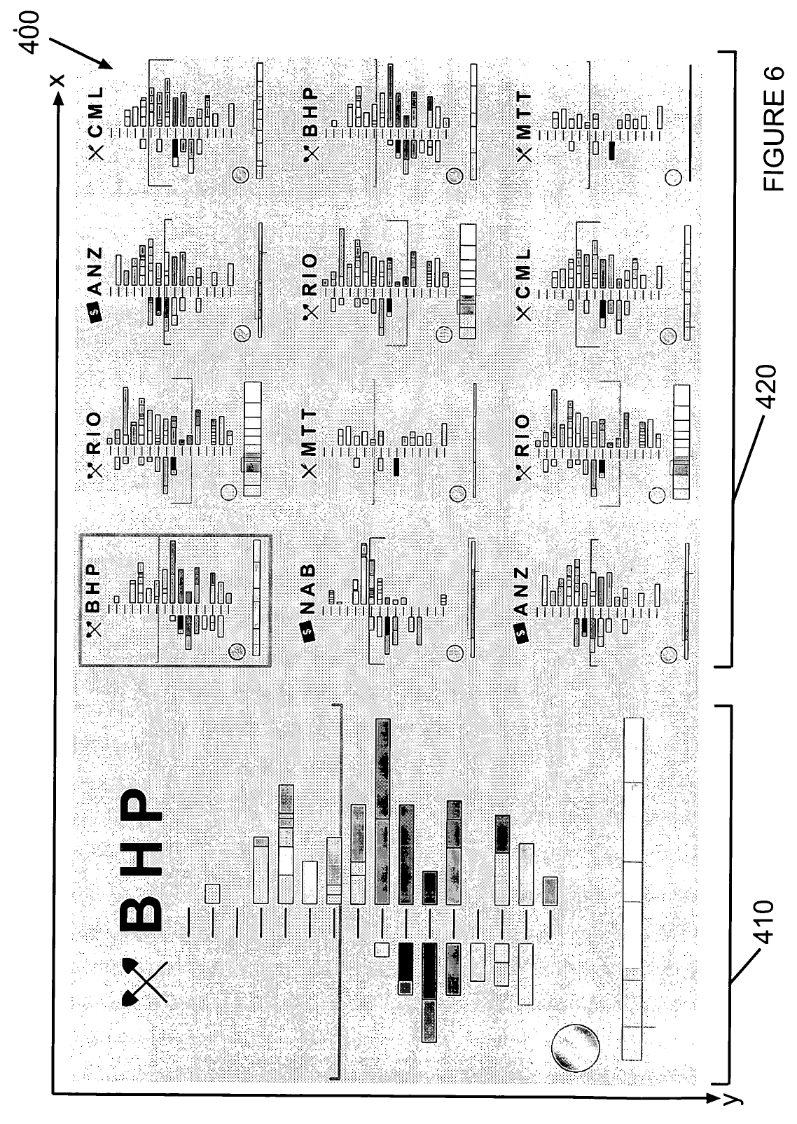

Referring to FIG. 6, the invention could also provide a display 400 to a user on client 20 involving more than one type of stock. The representation 400 preferably includes a focus window 410 showing in detail one of the stocks under consideration. Positioned adjacent the focus window 410 is preferably a thumb nail window 420 showing a series of smaller representations of stocks and order books. The thumb nail window 420 represents context across all stocks of interest, including for example the order book or watch list. Although the representations are smaller, significant elements of the visualisations are represented as the most striking using the techniques described above giving indications of market depth, spread, price, trends, urgent orders and opportunities and threats. In this way, the user can readily appreciate the entire market at a glance and have the ability to focus on a particular market when desired.

In a further preferred form, the display could be arranged to show summary images of abstract structures, for example various aspects of the stock market. The summary images could include contours, shaded thematics, labels and icons. The images could be in macro media flash format or any other format enabling interactive vector graphics.

The foregoing describes the invention including preferred forms thereof. Alterations and modifications as will be obvious to those skilled in the art are intended to be incorporated within the scope hereof, as defined by the accompanying claims.

1. A trading data visualisation system comprising:
a transaction database stored in computer memory of transaction data representing transactions and desired transactions in relation to one or more tradable items, the transaction data comprising one or more data sets, one or more of the data sets comprising an item identifier, a transaction identifier and an item volume value;
a retrieval component configured to retrieve transaction data from the transaction database; and
a display configured to display one or more graphical representations of some or all of the transaction data including at least one desired transaction, the size of one or more of the graphical representations proportional to the volume of tradable items represented by the transaction data.

2. A trading data visualisation system as claimed in claim 1 wherein one or more of the data sets includes a time value.

3. A trading data visualisation system as claimed in claim 2 wherein one or more of the graphical representations has a colour property based on the time value in each data set.

4. A trading data visualisation as claimed in claim 2 wherein the display is configured to display two or more graphical representations of some or all of the transaction data, the graphical representations positioned relative to the other graphical representation(s) based on the time value in each data set.

5. A trading data visualisation system as claimed in claim 1 wherein one or more of the graphical representations has a colour property based on the transaction identifier in each data set.

6. A trading data visualisation system as claimed in claim 1 wherein one or more of the data sets includes a currency value.

7. A trading data visualisation system as claimed in claim 6 wherein the display is configured to display two or more graphical representations, each graphical representation positioned relative to the other graphical representation(s) based on the currency value in each data set.

8. A trading data visualisation system as claimed in claim 1 wherein the display is configured to display two or more graphical representations, the graphical representations positioned relative to the other graphical representation(s) based on the transaction identifier in each data set.

9. A method of visualising trading data comprising the steps of:
maintaining in computer memory a transaction database of transaction data representing offers for sale, offers to buy and concluded sales in relation to one or more tradable items, the transaction data comprising one or more data sets, one or more of the data sets comprising an item identifier, a transaction identifier and an item volume value;
retrieving transaction data from the transaction database; and
displaying one or more graphical representations of some or all of the transaction data including at least one offer for sale or offer to buy, the size of one or more of the graphical representations proportional to the volume of tradable items represented by the transaction data.

10. A method of visualising trading data as claimed in claim 9 wherein one or more of the data sets includes a time value.

11. A method of visualising trading data as claimed in claim 10 further comprising the step of displaying one or more of the graphical representations with a colour property based on the time value in each data set.

12. A method of visualising trading data as claimed in claim 10 further comprising the step of displaying two or more graphical representations of some or all of the transaction data, the graphical representations positioned relative to the other graphical representation(s) based on the time value in each data set.

13. A method of visualising trading data as claimed in claim 9 further comprising the step of displaying one or more graphical representations with a colour property based on the transaction identifier in each data set.

14. A method of visualising trading data as claimed in claim 9 wherein one or more of the data sets includes a currency value.

15. A method of visualising trading data as claimed in claim 14 further comprising the step of displaying two or more graphical representations, the graphical representations positioned relative to the other graphical representation(s) based on the currency value in each data set.

16. A method of visualising trading data as claimed in claim 9 further comprising the step of displaying two or more graphical representations, the graphical representations positioned relative to the other graphical representation(s) based on the transaction identifier in each data set.

17. A trading data visualisation system comprising:
a transaction database stored in computer memory of transaction data representing transactions and desired transactions in relation to one or more tradable items, the transaction data comprising one or more data sets, one or more of the data sets comprising an item identifier, a transaction identifier and an item volume value;
a retrieval component configured to retrieve transaction data from the transaction database; and
a display configured to display one or more graphical representations of some or all of the transaction data including at least one desired transaction, the size of one or more of the graphical representations proportional to the volume of tradable items represented by the transaction data.

18. A trading data visualisation system as claimed in claim 17 wherein one or more of the data sets includes a time value and/or a currency value.

19. A trading data visualisation system as claimed in claim 18 wherein one or more of the graphical representations has a colour property based on the time value and/or currency value in each data set.

20. A trading data visualisation system as claimed in claim 18 wherein the display is configured to display two or more graphical representations, the graphical representations positioned relative to the other graphical representation(s) based on the time value and/or currency value in each data set.

21. A trading data visualisation system as claimed in claim 17 wherein one or more of the graphical representations has a colour property based on the transaction identifier in each data set.

22. A trading data visualisation system as claimed in claim 17 wherein the display is configured to display two or more graphical representations, the graphical representations positioned relative to the other graphical representation(s) based on the transaction identifier in each data set.

23. A method of visualising trading data comprising the steps of:
maintaining in computer memory a transaction database of transaction data representing offers for sale, offers to buy and concluded sales in relation to one or more tradable items, the transaction data comprising one or more data sets, one or more of the data sets comprising an item identifier, a transaction identifier and an item volume value;
retrieving transaction data from the transaction database; and displaying one or more graphical representations of some or all of the transaction data including at least one offer for sale or offer to buy, the size of one or more of the graphical representations proportional to the volume of tradable items represented by the transaction data.

24. A method of visualising trading data as claimed in claim 23 wherein one or more of the data sets includes a time value and/or a currency value.

25. A method of visualising trading data as claimed in claim 23 further comprising the step of displaying one or more of the graphical representations with a colour property based on the time value and/or currency value in each data set

26. A method of visualising trading data as claimed in claim 24 further comprising the step of displaying two or more graphical representations of some or all of the transaction data, the graphical representations positioned relative to the other graphical representation(s) based on the time value and/or currency value in each data set.

27. A method of visualising trading data as claimed in claim 23 further comprising the step of displaying one or more graphical representations with a colour property based on the transaction identifier in each data set.

28. A method of visualising trading data as claimed in claim 23 further comprising the step of displaying two or more graphical representations, the graphical representations positioned relative to the other graphical representation(s) based on the transaction identifier in each data set.

29. A trading data visualisation system comprising:
a transaction database stored in computer memory of transaction data representing transactions and desired transactions in relation to one or more tradable items, the transaction data comprising one or more data sets, one or more of the data sets comprising an item identifier, a transaction identifier and an item volume value;
a retrieval component configured to retrieve transaction data from the transaction database; and
a display configured to display one or more graphical representations of some or all of the transaction data including at least one desired transaction, the size of one or more of the graphical representations proportional to the volume of tradable items represented by the transaction data.

30. A trading data visualisation system as claimed in claim 29 wherein one or more of the data sets includes a time value.

31. A trading data visualisation system as claimed in claim 30 wherein one or more of the graphical representations has a colour property based on the time value in each data set.

32. A trading data visualisation system as claimed in claim 30 wherein the display is configured to display two or more graphical representations of some or all of the transaction data, the graphical representations positioned relative to the other graphical representation(s) based on the time value in each data set.

33. A trading data visualisation system as claimed in claim 29 wherein one or more of the data sets includes a currency value.

34. A trading data visualisation system as claimed in claim 33 wherein the display is configured to display two or more graphical representations, each graphical representation positioned relative to the other graphical representation(s) based on the currency value in each data set.

35. A trading data visualisation system as claimed in claim 29 wherein one or more of the graphical representations has a colour property based on the transaction identifier in each data set.

36. A trading data visualisation system as claimed in claim 29 wherein the display is configured to display two or more graphical representations, the graphical representations positioned relative to the other graphical representation(s) based on the transaction identifier in each data set.

37. A method of visualising trading data comprising the steps of:
maintaining in computer memory a transaction database of transaction data representing offers for sale, offers to buy and concluded sales in relation to one or more tradable items, the transaction data comprising one or more data sets, one or more of the data sets comprising an item identifier, a transaction identifier and an item volume value;
retrieving transaction data from the transaction database; and displaying one or more graphical representations of some or all of the transaction data including at least one offer for sale or offer to buy, the size of one or more of the graphical representations proportional to the volume of tradable items represented by the transaction data.

38. A method of visualising trading data as claimed in claim 37 wherein one or more of the data sets includes a time value.

39. A method of visualising trading data as claimed in claim 38 further comprising the step of displaying one or more of the graphical representations with a colour property based on the time value in each data set.

40. A method of visualising trading data as claimed in claim 38 further comprising the step of displaying two or more graphical representations of some or all of the transaction data, each graphical representation positioned relative to the other graphical representation(s) based on the time value in each data set.

41. A method of visualising trading data as claimed in claim 37 wherein one or more of the data sets includes a currency value.

42. A method of visualising trading data as claimed in claim 41 further comprising the step of displaying two or more graphical representations, the graphical representations positioned relative to the other graphical representation(s) based on the currency value in each data set.

43. A method of visualising trading data as claimed in claim 37 further comprising the step of displaying one or more of the graphical representations with a colour property based on the transaction identifier in each data set.

44. A method of visualising trading data as claimed in claim 37 further comprising the step of displaying two or more graphical representations, the graphical representations positioned relative to the other graphical representation(s) based on the transaction identifier in each data set.
